(19) United States
(12) Patent Application Publication
(10) Pub. No.: US 2010/0174894 A1
(43) Pub. Date: Jul. 8, 2010

(54) Method, Apparatus, and System for Configuring an Operating System on a Target Computer

(75) Inventors: Liang Chen, Raleigh, NC (US); Joshua Neil Novak, Wake Forest, NC (US); Rod D. Waltermann, Rougemont, NC (US); Yi Zhou, Raleigh, NC (US)

Correspondence Address: Kunzler Needham Massey & Thorpe, 8 EAST BROADWAY, SUITE 600, SALT LAKE CITY, UT, 84111, US

(73) Assignee: LENOVO (SINGAPORE) PTE, LTD., New Tech Park (SG)

(21) Appl. No.: 12/350,138

(22) Filed: Jan. 7, 2009

(51) Int. Cl. G06F 15/177

(52) U.S. Cl. 713/2

(57) ABSTRACT

A method, apparatus, and system are disclosed for configuring an operating system on a target computer. A configuration module configures a target computer as a diskless client. A boot module boots the target computer to a setup state. A communication module establishes communications between the target computer, a donor storage device of a donor computer, and a virtual disk. A copy module copies a configuration image from the donor storage device to the virtual disk. The configuration image comprises an operating system and a software configuration installed on the donor computer. A modification module modifies the configuration image on the virtual disk to conform to a hardware configuration of the target computer.

### BACKGROUND OF THE INVENTION

1. Field of the Invention

This invention relates to configuring an operating system and more particularly relates to configuring an operating system on a target computer.

2. Description of the Related Art

When a computer initially installs an operating system from a non-volatile storage device such as a hard disk, the operating system may be unable to subsequently execute from a remote virtual disk. As a result, it is often difficult to install the operating system and configure the software for a diskless computer that runs from a remote virtual disk.

### SUMMARY OF THE INVENTION

From the foregoing discussion, there is a need for a method, apparatus, and system that configures an operating system on a target computer that is configured as a diskless computer. Beneficially, such a method, apparatus, and system would enable the target computer to execute an operating system from a remote virtual disk.

The present invention has been developed in response to the present state of the art, and in particular, in response to the problems and needs in the art that have not yet been fully solved by currently available apparatus, systems and methods for configuring an operating system. Accordingly, the present invention has been developed to provide an apparatus, system, and method for configuring an operating system that overcome many or all of the above-discussed shortcomings in the art.

The apparatus for configuring an operating system is provided with a plurality of modules configured to functionally execute the steps of configuring a target computer, booting the target computer, establishing communications, copying a configuration image, and modifying the configuration image. These modules in the described embodiments include a configuration module, a boot module, a communication module, a copy module, and a modification module.

The configuration module configures a target computer as a diskless client. The boot module boots the target computer to a setup state. The communication module establishes communications between the target computer, a donor storage device of a donor computer, and a virtual disk. The copy module copies a configuration image from the donor storage device to the virtual disk. The configuration image comprises an operating system and a software configuration installed on the donor computer. The modification module modifies the configuration image on the virtual disk to conform to a hardware configuration of the target computer.

A system of the present invention is also presented for configuring an operating system. In particular, the system, in one embodiment, includes a target computer, a donor computer, a virtual disk, a network, a configuration module, a boot module, a communication module, a copy module, and a modification module.

The donor computer comprises a donor storage device. A hardware configuration of the donor computer is equivalent to a hardware configuration of the target computer plus the donor storage device.

The configuration module configures the target computer as a diskless client. The boot module boots the target computer to a setup state. The communication module establishes communications between the target computer, the donor storage device, and the virtual disk over the network.

The copy module copies a configuration image from the donor storage device to the virtual disk. The configuration image comprises an operating system and a software configuration installed on the donor computer. The modification module modifies the configuration image on the virtual disk to conform to a hardware configuration of the target computer.

A method of the present invention is also presented for configuring an operating system. The method in the disclosed embodiments substantially includes the steps to carry out the functions presented above with respect to the operation of the described apparatus and system. In one embodiment, the method includes configuring a target computer, booting the target computer, establishing communications, copying a configuration image, and modifying the configuration image.

A configuration module configures a target computer as a diskless client. A boot module boots the target computer to a setup state. A communication module establishes communications between the target computer, a donor storage device of a donor computer, and a virtual disk. A copy module copies a configuration image from the donor storage device to the virtual disk. The configuration image comprises an operating system and a software configuration installed on the donor computer. A modification module modifies the configuration image on the virtual disk to conform to a hardware configuration of the target computer.

References throughout this specification to features, advantages, or similar language do not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

The present invention automates configuring an operating system on a target computer. Beneficially, such an apparatus, system, and method would automatically configure an operating system on a target computer so that the target computer may operate from a virtual disk. These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic diagram illustrating one embodiment of a system for configuring an operating system in accordance with the present invention;

FIG. 2 is a schematic block diagram illustrating one embodiment of a donor computer of the present invention;

FIG. 3 is a schematic block diagram illustrating one embodiment of a target computer of the present invention;

FIG. 4 is a schematic block diagram illustrating one embodiment of a configuration apparatus of the present invention;

FIG. 5 is a schematic flow chart diagram illustrating one embodiment of a method for configuring an operating system on a target computer of the present invention; and

FIG. 6 is a schematic flow chart diagram illustrating one embodiment of a method for booting a target computer of the present invention.

### DETAILED DESCRIPTION OF THE INVENTION

Many of the functional units described in this specification have been labeled as modules, in order to more particularly emphasize their implementation independence. Modules may include hardware circuits such as one or more processors with memory, Very Large Scale Integration (VLSI) circuits, gate arrays, programmable logic, and/or discrete components. The hardware circuits may perform logic functions, execute computer readable programs stored on tangible storage devices, and/or execute programmed functions. Modules may also include a computer readable storage medium comprising a computer readable program stored on a tangible storage device that performs a function when executed by a hardware circuits such as a processor, microcontroller, or the like.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

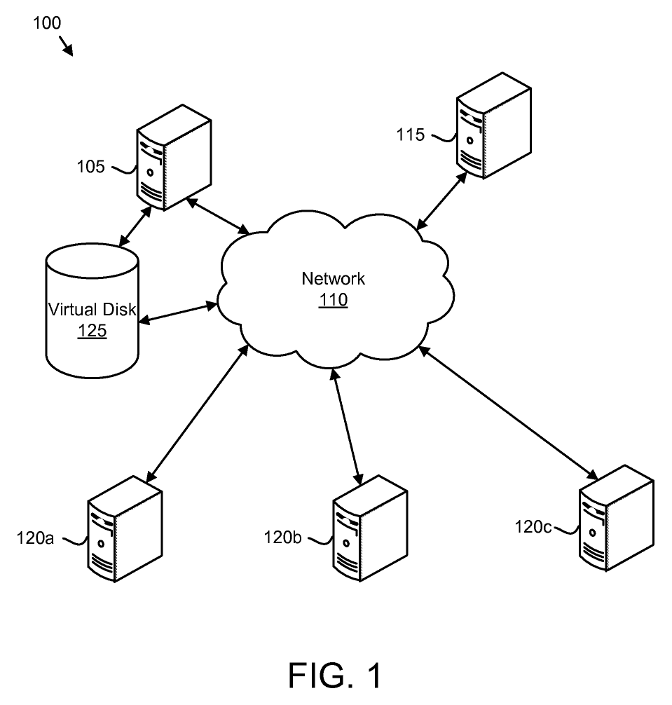

FIG. 1 is a schematic diagram illustrating one embodiment of a system 100 for configuring an operating system in accordance with the present invention. The system 100 includes a computer 105, a network 110, a donor computer 115, a plurality of target computers 120a-c, and virtual disk 125. Although, for simplicity, the system 100 is shown with one virtual disk 125, three (3) target computers 120a-c, one donor computer 115, one network 110, and one computer 105, any number of virtual disks 125, computers 105, donor computers 115, target computers 120, and networks 110 may be employed.

The computer 105, donor computer 115, and target computers 120 may each be configured as a desktop computer, a notebook computer, a mainframe computer, a blade center comprising multiple blade servers, or the like. The computer 105, donor computer 115, and target computers 120 may also include a display, a keyboard, a touchpad, or the like. In addition, the computer 105, donor computer 115, and target computers 120 may include hardware components, software components, and/or the like as is well known to those of skill in the art. The target computer 120 is configured as a diskless client. The computer 105 may configure the operating system on the target computer 120.

The network 110 may establish unidirectional communication, bi-directional communication, multidirectional communication, and/or a combination thereof between the plurality of target computers 120, the donor computer 115, and the computer 105. The communication over the network 110 may be through fiber optic cables, wires, wireless, or the like as is well known to those of skill in the art.

The network 110 may be selected from a dedicated fiber network, a local area network (LAN), a wide area network (WAN), the Internet, an Ethernet network, a token ring network, an enterprise intranet, the Internet Small Computer System Interface (iSCSI) network, and/or the like. The network 110 may comprise one or more nodes that may provide one or more physical and/or logical paths for transferring the data/code as is well known to those of skill in the art. For example, the network nodes may comprise one or more switches, routers, bridges, wireless LAN access points, or the like to transfer the data/code. In an embodiment, the system 100 configures the operating system on the target computer 120 as will be described hereafter.

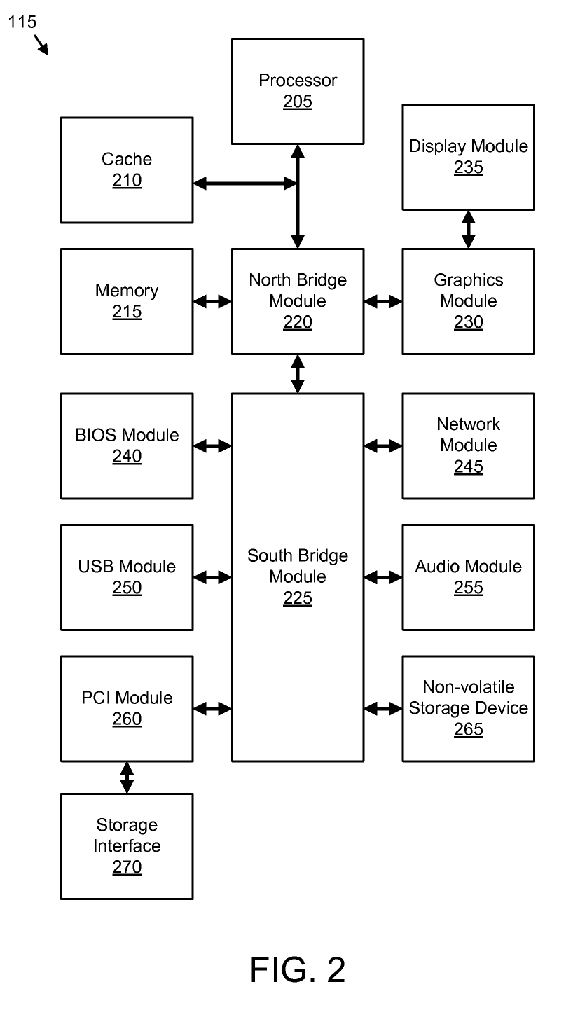

FIG. 2 is a schematic block diagram illustrating one embodiment of a donor computer 115 in accordance with the present invention. The donor computer 115 is the donor computer 115 of FIG. 1. The donor computer 115 includes a processor 205, a cache 210, a memory 215, a north bridge module 220, a south bridge module 225, a graphics module 230, a display module 235, a basic input-output system (BIOS) module 240, a network module 245, a Universal Serial Bus (USB) module 250, an audio module 255, a Peripheral Component Interconnect (PCI) module 260, a storage interface 270, and a non-volatile storage device 265.

Although for simplicity, one processor 205, one cache 210, one memory 215, one north bridge module 220, one south bridge module 225, one graphics module 230, one display module 235, one BIOS module 240, one network module 245, one USB module 250, one audio module 255, one PCI module 260, and one non-volatile storage device 265, and one storage interface 270 are shown with the donor computer 115, any number of processors 205, caches 210, memories 215, north bridge modules 220, south bridge modules 225, graphics modules 230, display modules 235, BIOS modules 240, network modules 245, USB modules 250, audio modules 255, PCI modules 260, storage interfaces 270, and non-volatile storage devices 265 may be employed. The description of the donor computer 115 refers to elements of FIG. 1, like numbers referring to like elements.

The processor 205, cache 210, memory 215, north bridge module 220, south bridge module 225, graphics module 230, display module 235, BIOS module 240, network module 245, USB module 250, audio module 255, PCI module 260, non-volatile storage device 265, and storage interface 270 are referred to herein as components. These modules/components may be fabricated of semiconductor gates on one or more semiconductor substrates. Each semiconductor substrate may be packaged in one or more semiconductor devices mounted on circuit cards. Connections between the plurality of components may be through semiconductor metal layers, substrate-to-substrate wiring, circuit card traces, and/or wires connecting the semiconductor devices.

The memory 215 may store executable code and data. The memory 215 may be selected from a Dynamic Random Access Memory (DRAM), a Static Random Access Memory (SRAM), a read only memory (ROM), a flash memory, and the like.

The processor 205 may process the executable code and data. The processor 205 may communicate over an integrated circuit (IC) processor bus for example, of two gigahertz (2 GHz) to process the executable code and data. The processor 205 may also include sufficient memory such as a plurality of system registers to store small quantity of data.

The donor computer 115 comprises a donor storage device. The donor storage device may be the non-volatile storage device 265. In an embodiment, a hardware configuration of the donor computer 115 is equivalent to the hardware configuration of the target computer 120 plus the donor storage device. For example, the donor computer 115 and the target computer 120 may include a keyboard, a processor, a memory, a display, or the like. In addition, the donor computer 115 may include a storage device and the target computer 120 may not include the donor storage device.

The non-volatile storage device 265 may be selected from one or more tangible storage devices such as optical storage devices, holographic storage devices, micromechanical storage devices, semiconductor storage devices, hard disk drives, magnetic tapes, and the like. The non-volatile storage device 265 may communicate with the south bridge module 225 to store code and data and/or access stored code and data. The code and data may tangibly be stored on the non-volatile storage device 265. The code and data may include a configuration module, a boot module, a communication module, a copy module, a modification module, a configuration image, a hardware profile, and an injection scheme.

The non-volatile storage device 265 may store the data in one or more files. For example, the non-volatile storage device 265 may store the data in one or more files of certain size in appropriate directories using a disk file systems such as file allocation table (FAT), new technology file system (NTFS), hierarchical file system (HFS), hierarchical file system plus (HFS+), second extended file system (ext2), third extended file system (ext3), or the like.

The storage interface 270 may include one or more interface standards for connection of non-volatile storage devices 265 such as solid-state drives, compact disk read only memory (CD-ROM) drives, or the like.

The processor 205 may communicate with the cache 210 through a processor interface bus to reduce average time to access the memory 215. The cache 210 may store copies of the data from the most frequently used storage module locations. The cache 210 may be controlled by a microcontroller in the non-volatile storage device 265. The microcontroller may be a single IC and may have sufficient memory and interfaces needed for an application. The donor computer 115 may use one or more caches 210 such as DDR2 cache memories as is well known to those of skill in the art.

The north bridge module 220 may communicate with and hence may provide a bridging functionality between the processor 205 and the graphics module 230 through a 26-lane PCI express bus, the memory 215, and the cache 210. The north bridge module 220 may be configured as an IC as is well known to those of skill in the art. The processor 205 may be connected to the north bridge module 220 over, for example, a six hundred sixty seven Megahertz (667 MHz) front side bus as is well known to those of skill in the art.

The north bridge module 220 may be connected to the south bridge module 225 through a direct media interface (DMI) bus. The DMI bus may provide a high-speed bi-directional point-to-point link supporting a clock rate for example of the value of two gigabytes per second (2 GBps) in each direction between the north bridge module 220 and the south bridge module 225. The south bridge module 225 may be configured as an IC as is well known to those of skill in the art.

The south bridge module 225 may also include an integrated USB controller. The south bridge module 225 may communicate with the USB module 250 through the USB controller. The USB controller may support a Bluetooth interface, a built-in camera, a built-in track pad, a keyboard, an expresscard/34 slot, an external USB port, or the like.

In addition, the south bridge module 225 may communicate with the audio module 255 through an input-output (I/O) device. The audio module 255 may support a built-in microphone, a combination analog audio line-in and Digital Interconnect Format (DIF) digital optical audio line-in jack, a combined analog output and DIF digital optical audio line-out jack, or the like.

The PCI module 260 may communicate with the south bridge module 225 for transferring data or to power peripheral devices. The PCI module 260 may include a PCI bus for attaching the peripheral devices. The PCI bus can logically connect with one or more peripheral devices such as printers, scanners, or the like. The PCI module 260 may be configured as a planar device IC and fitted onto a motherboard. The PCI module 260 may also be configured as an expansion card as is well known to those of skill in the art.

The network module 245 may communicate with the south bridge module 225 to allow the donor computer 115 to communicate with other devices over a network 110. The devices may include routers, bridges, computers, printers, and the like.

The BIOS module 240 may communicate instructions through the south bridge module 225 to boot the donor computer 115, so that software instructions stored on the memory 215 can load, execute, and assume control of the donor computer 115. Alternatively, the BIOS module 240 may comprise code and data embedded on a chipset that recognizes and controls various devices that make up the donor computer 115.

For example, the BIOS module 240 may carry out a Power On Self Test (POST) that may ensure that the donor computer 115 meets requirements to start-up properly, load a bootstrap loader to locate an operating system, load a BIOS program or one or more drivers that interface between the operating system and the hardware devices, and load a configuration program that may allow to configure hardware configuration options such as a hardware password, time, date, and/or the like. The display module 235 may communicate with the graphics module 230 to display the hardware configuration options such as the hardware password, time, date, or the like.

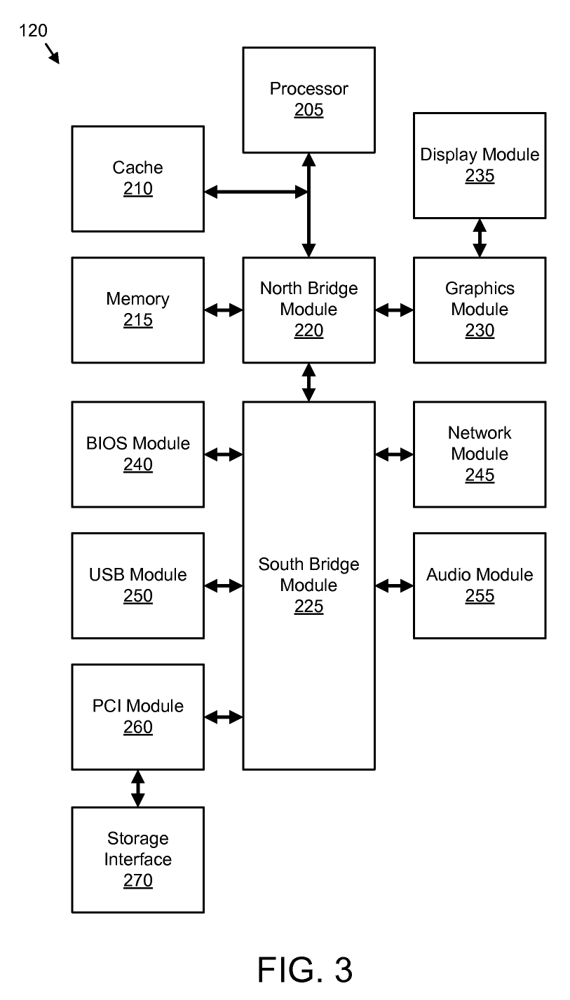

FIG. 3 is a schematic block diagram illustrating one embodiment of the target computer 120 in accordance with the present invention. The target computer 120 is the target computer 120 of FIG. 1. The target computer 120 includes the processor 205, the cache 210, the memory 215, the north bridge module 220, the south bridge module 225, the graphics module 230, the display module 235, the BIOS module 240, the network module 245, the USB module 250, the audio module 255, the PCI module 260, and the storage interface 270 of FIG. 2. The description of the target computer 120 refers to elements of FIGS. 1-2, like numbers referring to like elements, wherein the functions of like-numbered elements are equivalent.

The target computer 120 is configured as a diskless client. The target computer 120 may not include the non-volatile storage device 265. In another embodiment, the target computer 120 may include one or more disabled non-volatile storage devices 265.

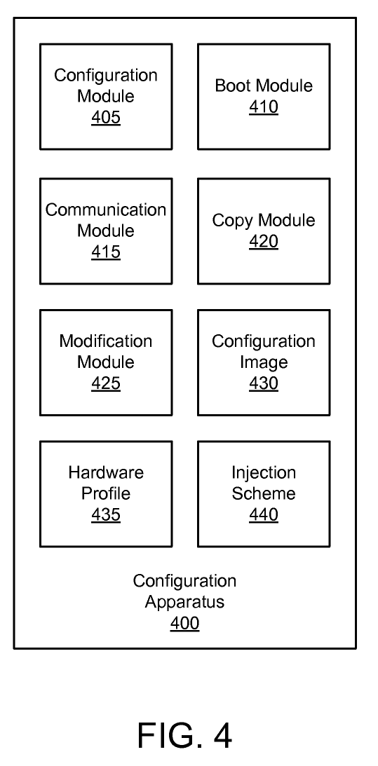

FIG. 4 is a schematic block diagram illustrating one embodiment of a configuration apparatus 400 of the present invention. The configuration apparatus 400 may be embodied in the computer 105 of FIG. 1. The apparatus 400 automates configuring the operating system on the target computer 120. The description of apparatus 400 refers to elements of FIGS. 1-3, like numbers referring to like elements. The apparatus 400 includes a configuration module 405, a boot module 410, a communication module 415, a copy module 420, a modification module 425, a configuration image 430, a hardware profile 435, and an injection scheme 440.

The configuration module 405 configures the target computer 120 as a diskless client. The target computer 120 may be one of the plurality of target computers 120a-c of FIG. 1 or the target computer 120 of FIG. 3.

The boot module 410 boots the target computer 120 to a setup state. In an embodiment, the setup state comprises a WINDOWS® Pre-install Environment. The WINDOWS® Pre-install Environment may control an early boot process of the target computer 120, initiate deployment of the operating system, or the like as is well known to those of skill in the art. The operating system may include a WINDOWS® Vista operating system, a WINDOWS® XP operating system, a WINDOWS® Server 2003 operating system, or the like.

The WINDOWS® Pre-install Environment may also enable loading and accessing device drivers, formatting disks with NTFS file system without using third-party utilities, or the like. For example, one or more thirty two (32) bit and/or sixty four (64) bit mass-storage device drivers and/or plug and play device drivers, networking device drivers, audio device drivers, video device drivers, and/or the like may directly be injected into an existing copy of the WINDOWS® Pre-install Environment on the target computer 120.

The target computer 120 in the setup state may create the hardware profile 435 for a target computer hardware configuration. The target computer hardware configuration may describe the components/modules of FIG. 3. The target computer hardware configuration may be equivalent to a hardware configuration of the donor computer 115 minus the donor storage device.

The hardware profile 435 for the target computer hardware configuration may comprise one or more configuration information such as a type, an identification mark, a vendor's name, and/or the like for the processor 205, cache 210, BIOS module 240, or the like, keyboard and mouse information, printer and scanner information, and the like.

The communication module 415 establishes communications between the target computer 120, the donor storage device of donor computer 115, and a virtual disk 125. The virtual disk 125 is organized on a storage device. For example, the virtual disk 125 may be organized on the storage device of the computer 105. Continuing with the above example, the communication module 415 may establish communications between the target computer 120, the donor storage device configured as the non-volatile storage device 265 of donor computer 115, and the virtual disk 125 organized on the storage device such as a hard disk drive of the computer 105.

The communication module 415 may further download a hypervisor to the target computer 120, installing the hypervisor on the target computer 120, and presenting the virtual disk 125 as a target computer non-volatile storage device. The hypervisor may be a virtualization program such as virtual machine monitor (VMM) such as Lenovo's Client Virtualization Platform (LCVP) hypervisor, or the like. Hardware of a single computer may be organized to simulate the operation of two or more virtual computers by employing the hypervisor.

The copy module 420 copies the configuration image 430 from the donor storage device to the virtual disk 125. The configuration image 430 comprises the operating system and a software configuration installed on the donor computer 115. For example, the configuration image 430 may comprise the WINDOWS® XP operating system and the MICROSOFT® Office installed on the donor computer 115.

In an embodiment, the configuration image 430 further comprises partitioning and file system information for the donor storage device. For example, the configuration image 430 may comprise a partitioning policy for one or more the non-volatile storage devices 265 file system information such as one or more directory names, file names, file sizes, disk file system used to store the files, or the like for the donor storage device.

The configuration image 430 may also comprise a WINDOWS® operating system registry. The WINDOWS® operating system registry may be a directory storing settings and options for the WINDOWS® operating system, the hardware configuration of the donor computer 115, configuration information of Win32-based Plug and Play devices, user preferences, or the like. The WINDOWS® operating system registry may also store and reflect changes made by a user in settings such as one or more control panel settings, file associations, system policies, most installed software, or the like.

The modification module 425 modifies the configuration image 430 on the virtual disk 125 to conform to the hardware configuration of the target computer 120. In an embodiment, the modification module 425 modifies the configuration image 430 on the virtual disk 125 to conform to the hardware configuration of the target computer 120 by creating the injection scheme 440 from the hardware profile 435 and copying the injection scheme 440 to the virtual disk 125.

The injection scheme 440 may comprise device drivers and changes to the WINDOWS® operating system registry conforming to the target computer hardware configuration. For example, the injection scheme 440 may comprise one or more device drivers such as for the plug and play device drivers and changes such as one or more changes in settings of control panel, file associations, system policies, most installed software, or the like, changes in one or more options for the WINDOWS® operating system, user preferences, or the like, and the like to the WINDOWS® operating system registry that conform to the target computer hardware configuration.

The configuration module 405, boot module 410, communication module 415, copy module 420, modification module 425 may each include a computer readable program stored on a tangible storage device. The computer readable programs may be executed on the computer 105, the donor computer 115, and/or the target computer 120. In one embodiment, the computer readable programs are stored on the memory 215 and executed by the processor 205 of the computer 105, donor computer 115, and/or target computer 120.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

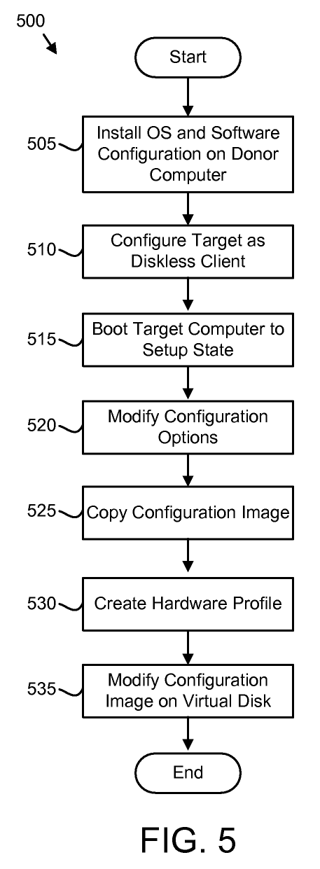

FIG. 5 is a schematic flow chart diagram illustrating one embodiment of a method 500 for configuring an operating system on a target computer 120 of the present invention. The method 500 substantially includes the steps to carry out the functions presented above with respect to the operation of the described system 100, apparatus 400, donor computer 115, and the target computer 120. The description of the method 500 refers to elements of FIGS. 1-4, like numbers referring to like elements.

In one embodiment, the method 500 is implemented with a computer readable storage medium comprising a computer readable program stored on a tangible storage device. The computer readable storage medium may be integrated into a computing system, such as the computer 105, wherein the computer readable program executed by the computing system performs the method 500.

The method 500 begins, and in one embodiment, the computer 105 installs 505 the operating system and software configuration on the donor computer 115. For example, when the computer 105 boots the donor computer 115, the BIOS module 240 may automatically load the bootstrap loader to locate the operating system, load the BIOS program or drivers that interface between the operating system, one or more software configurations, and hardware devices.

The configuration module 405 configures 510 the target computer 120 as the diskless client. For example, the configuration module 405 may configure 510 the target computer 120 as the diskless client by automatically disabling each non-volatile storage device driver on the target computer 120. In another example, the configuration module 405 may configure 510 the target computer 120 as the diskless client by automatically detecting that the target computer 120 includes no non-volatile storage device 265.

The boot module 410 boots 515 the target computer 120 to the setup state. In an embodiment, the setup state comprises a WINDOWS® Pre-install Environment. In an embodiment, the boot module 410 boots 515 the target computer 120 from a Compact Disk (CD). The CD may comprise code and instructions that configure the WINDOWS® Pre-install Environment as is well known to those of skill in the art. For example, the boot module 410 may employ the BIOS module 240 that may refer the CD comprising the WINDOWS® Pre-install Environment to boot 605 the target computer 120. Alternatively, the boot module 410 may boot 515 the target computer 120 over a network 110 such as an iSCSI network.

The modification module 425 may modify 520 configuration options. In one embodiment, the modification module 425 modifies 520 the configuration options by presenting the configuration options to the user and receiving modifications to the configuration options from the user. The configuration options may be for the target computer 120 or the donor computer 115.

The configuration options may comprise a plurality of hardware and software configuration options as is well known to those of skill in the art. For example, the hardware configuration options may include the hardware password, time, date, or the like and the software configuration options may include an update routine, a user identification, a password or a key to use a software program, or the like.

In an example, the modification module 425 may automatically display configuration options on the display module 255 to present the configuration options to the user. The user may use the keyboard to modify the configuration options. The modification module 425 may further receive modifications to the configuration options and then automatically modify 520 the configuration options.

The copy module 420 copies 525 the configuration image 430 from the donor storage device to the virtual disk 125. The virtual disk 125 may be embodied in the computer 105, a storage system accessible through the network 110, or the like. The configuration image 430 comprises the operating system and the software configuration installed on the donor computer 115.

The configuration image 430 may further comprise partitioning and file system information for the donor storage device. The configuration image 430 may also comprise a WINDOWS® operating system registry. For example, the copy module 420 may copy 525 the configuration image 430 that comprises the operating system such as WINDOWS® XP and the software configuration such as MICROSOFT® Office installed on the donor computer 115, the partitioning policy for the non-volatile storage device 265, and the file system information such as one or more directory names, file names, file sizes, disk file system used to store the files, or the like for the donor storage device, and the WINDOWS® operating system registry from the donor storage device to the virtual disk 125.

The target computer 120 in the setup state may create 530 the hardware profile 435 for the target computer hardware configuration. For example, the target computer 120 in the setup state may automatically create 530 the hardware profile 435 that may comprise configuration information such as the type, the identification mark, the vendor's name, and/or the like for the processor 205, cache 210, memory 215, north bridge module 220, south bridge module 225, graphics module 230, display module 235, BIOS module 240, network module 245, USB module 250, audio module 255, PCI module 260, and storage interface 270 of the target computer 120.

The modification module 425 modifies 535 the configuration image 430 on the virtual disk 125 to conform to the hardware configuration of the target computer 120 and the method 500 terminates. The modification module 425 may modify 535 the configuration image 430 on the virtual disk 125 to conform to the hardware configuration of the target computer 120 by creating the injection scheme 440 from the hardware profile 435 and copying the injection scheme 440 to the virtual disk 125. In an embodiment, the injection scheme 440 comprises device drivers and changes to the WINDOWS® operating system registry conforming to the target computer hardware configuration.

For example, the modification module 425 may automatically modify 535 the configuration image 430 by creating the injection scheme 440 that comprises device drivers for the processor 205, cache 210, memory 215, north bridge module 220, south bridge module 225, graphics module 230, display module 235, BIOS module 240, network module 245, USB module 250, audio module 255, PCI module 260, storage interface 270, and the like of the target computer 120. The configuration image may further include changes to the WINDOWS® operating system registry such as one or more changes in settings of control panel, file associations, system policies, most installed software, or the like, changes in one or more options for the WINDOWS® operating system, user preferences, or the like. Thus, the method 600 configures the operating system on the virtual disk 125 to conform to the hardware configuration of the target computer 120.

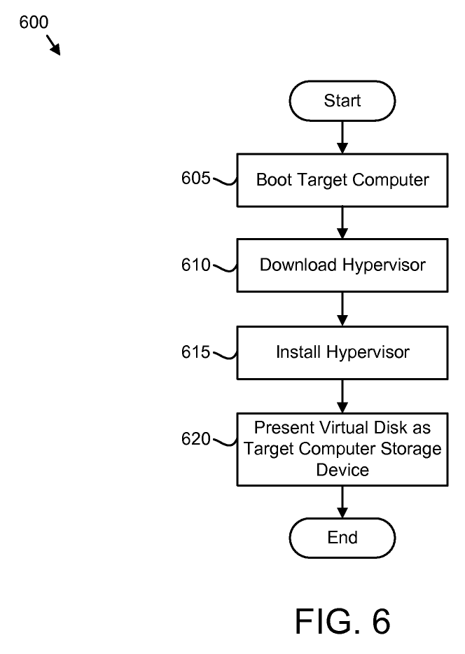

FIG. 6 is a schematic flow chart diagram illustrating one embodiment of a method 600 for booting a target computer of the present invention. The method 600 substantially includes the steps to carry out the functions presented above with respect to the operation of the described system 100, apparatus 400, donor computer 115, target computer 120, and method 500. The description of the method 600 refers to elements of FIGS. 1-5, like numbers referring to like elements.

In one embodiment, the method 600 is implemented with a computer readable storage medium comprising a computer readable program stored on a tangible storage device. The computer readable storage medium may be integrated into a computing system, such as the computer 105, wherein the computer readable program executed by the computing system performs the method 600.

The method 600 begins, and in one embodiment, the boot module 410 boots 605 the target computer 120. The boot module 410 may boot 605 the target computer over a network 110. Alternatively, the boot module 410 may boot 605 the target computer in response to the user powering up the target computer 120.

The communication module 415 downloads 610 the hypervisor to the target computer 120. In an embodiment, the communication module 415 downloads 610 the hypervisor over an iSCSI network. For example, the communication module 415 may automatically download code and instructions that configure the hypervisor over the iSCSI network from a website or a software repository and store the downloaded code and instructions in the memory 215 of the target computer 120. Alternatively, the communication module 415 may download 610 the hypervisor from a CD.

In addition, the communication module 415 installs 615 the hypervisor on the target computer 120. The hypervisor may organize a virtual disk 125 of the computer 105 or a storage system as a non-volatile storage device for the target computer 120.

The communication module 415 presents 620 the virtual disk 125 as the target computer non-volatile storage device and the method 600 terminates. Thus, the method 600 enables booting the target computer 120.

The present invention automates configuring an operating system on the target computer 120. Beneficially, such an apparatus, system, and method would automatically configure the operating system on the target computer 120 so that the target computer 120 may operate from the virtual disk 125. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer readable storage medium comprising a computer readable program: stored on a tangible storage device for configuring an operating system on a target computer, wherein the computer readable program when executed on at least one computer causes the at least one computer to:
configure a target computer as a diskless client;
boot the target computer to a setup state;
establish communications between the target computer, a donor storage device of a donor computer, and a virtual disk;
copy a configuration image from the donor storage device to the virtual disk, the configuration image comprising an operating system and a software configuration installed on the donor computer; and
modify the configuration image on the virtual disk to conform to a hardware configuration of the target computer.

2. The computer readable storage medium of claim 1, wherein a hardware configuration of the donor computer is equivalent to the hardware configuration of the target computer plus the donor storage device.

3. The computer readable storage medium of claim 1, wherein the configuration image further comprises partitioning and file system information for the donor storage device.

4. The computer readable storage medium of claim 1, wherein the computer readable program further causes the at least one computer to boot the target computer from a Compact Disk (CD).

5. The computer readable storage medium of claim 1, wherein the computer readable program further causes the at least one computer to boot the target computer over a network.

6. The computer readable storage medium of claim 1, wherein the setup state comprises a pre-install environment.

7. The computer readable storage medium of claim 1, wherein the configuration image comprises an operating system registry.

8. The computer readable storage medium of claim 7, wherein the target computer in the setup state creates a hardware profile for the target computer hardware configuration.

9. The computer readable storage medium of claim 8, wherein the computer readable program further causes the at least one computer to modify the configuration image on the virtual disk by:
creating an injection scheme from the hardware profile, the injection scheme comprising device drivers and changes to the operating system registry conforming to the target computer hardware configuration; and
copying the injection scheme to the virtual disk.

10. The computer readable storage medium of claim 1, wherein the computer readable program further causes the at least one computer to modify configuration options by presenting the configuration options to a user and receiving modifications to the configuration options from the user.

11. The computer readable storage medium of claim 1, wherein the computer readable program further causes the at least one computer to:
boot the target computer;
download a hypervisor to the target computer;
install the hypervisor on the target computer; and
present the virtual disk as a target computer non-volatile storage device.

12. The computer readable storage medium of claim 11, wherein the computer readable program further causes the at least one computer to download the hypervisor over an Internet Small Computer System Interface (iSCSI) network.

13. An apparatus comprising:
a configuration module configuring a target computer as a diskless client;
a boot module booting the target computer to a setup state;
a communication module establishing communications between the target computer, a donor storage device of a donor computer, and a virtual disk;
a copy module copying a configuration image from the donor storage device to the virtual disk, the configuration image comprising an operating system and a software configuration installed on the donor computer; and
a modification module modifying the configuration image on the virtual disk to conform to a hardware configuration of the target computer.

14. The apparatus of claim 13, wherein a hardware configuration of the donor computer is equivalent to the hardware configuration of the target computer plus the donor storage device and the configuration image further comprises partitioning and file system information for the donor storage device.

15. The apparatus of claim 13, wherein the setup state comprises a pre-install environment, the configuration image comprises an operating system registry, the target computer in the setup state creates a hardware profile for the target computer hardware configuration.

16. The apparatus of claim 15, wherein the modification module modifies the configuration image on the virtual disk to conform to a hardware configuration of the target computer by:
creating an injection scheme from the hardware profile, the injection scheme comprising device drivers and changes to the operating system registry conforming to the target computer hardware configuration; and
copying the injection scheme to the virtual disk.

17. A system comprising:
a target computer;
a donor computer comprising a donor storage device, wherein a hardware configuration of the donor computer is equivalent to a hardware configuration of the target computer plus the donor storage device;
a virtual disk organized on a storage device;
a network;
a configuration module configuring the target computer as a diskless client;
a boot module booting the target computer to a setup state;
a communication module establishing communications between the target computer, the donor storage device, and the virtual disk over the network;
a copy module copying a configuration image from the donor storage device to the virtual disk, the configuration image comprising an operating system and a software configuration installed on the donor computer; and
a modification module modifying the configuration image on the virtual disk to conform to a hardware configuration of the target computer.

18. The system of claim 17,
the boot module further booting the target computer; and
the communication module further downloading a hypervisor to the target computer, installing the hypervisor on the target computer, and presenting the virtual disk as a target computer non-volatile storage device.

19. The system of claim 17, wherein the configuration image further comprises partitioning and file system information for the donor storage device.

20. The system of claim 17, wherein the setup state comprises a pre-install environment, the configuration image comprises an operating system registry, and the target computer in the setup state creates a hardware profile for the target computer hardware configuration.
